(19) United States
(12) Patent Application Publication
(10) Pub. No.: US 2021/0142366 A1
(43) Pub. Date: May 13, 2021

(54) METHOD AND SYSTEM TO RUN TARGETED MARKETING CAMPAIGNS THROUGH ONE OR MORE TELECOMMUNICATION CHANNELS

(71) Applicant: Terragon Holdings Mauritius, Ebene (MU)

(72) Inventors: Elochukwu UMEH, Lagos (NG); Ayodeji BALOGUN, Lagos (NG); Amit KHEMCHANDANI, Bengaluru (IN); Mohit RAWAT, Bengaluru (IN)

(73) Assignee: Terragon Holdings Mauritius, Ebene (MU)

(21) Appl. No.: 16/680,413

(22) Filed: Nov. 11, 2019

(51) Int. Cl. G06Q 30/02; G06F 16/23; G06N 20/00; G06N 5/04

(52) U.S. Cl. CPC G06Q 30/0269; G06N 5/047; G06N 20/00; G06F 16/2379

(57) ABSTRACT

The present disclosure provides a computer-implemented method and system for running highly targeted marketing campaigns through one or more telecommunication channels. The computer-implemented method and system corresponds to an advertising system. The advertising system receives a user data associated with a plurality of users. In addition, the advertising system collects a user activity data. Further, the advertising system analyzes the user data and the user activity data. Furthermore, the advertising system creates a plurality of user profiles. Moreover, the advertising system segregates the plurality of user profiles. The advertising system identifies each of the plurality of users based on analysis of corresponding plurality of user profiles for initiating one or more marketing campaigns. The advertising system triggers initialization of the one or more marketing campaigns. The advertising system displays one or more advertisements associated with the one or more marketing campaigns based on identified users of the plurality of users.

### TECHNICAL FIELD

The present invention relates to the field of marketing and, in particular, relates to running targeted marketing campaigns through one or more telecommunication channels.

### BACKGROUND

Over the past few years, targeted marketing is the fastest growing advertising medium in the field of telecommunication industry. Improvements in the telecommunication technologies have led to an increase in the number of advertisements provided by advertisers offering value added services. Advertisers offer numerous products which might include: voice services; data services such as text messaging and multimedia messaging, location based services; and internet access. The telecommunication industry has created rigorous competition between the advertisers. In addition, advertisers must aggregate or develop comprehensive content and services that matches the interests and the needs of customers. Advertisers run basic business practices for targeted marketing through analysis of customer behavior and communication with customers through a variety of channels. Nowadays, advertisers have started leveraging existing native telecom channels to display advertisements to the users. Currently, the telecom companies append marketing native notification channels either based on random selection, time based or pre selection. The same marketing messages are seen by all subscribers that generate a notification within the same time window.

### SUMMARY

In a first example, a computer-implemented method is provided. The computer-implemented method is configured for running highly targeted marketing campaigns through one or more telecommunication channels. The computer implemented method corresponds to an advertising system with a processor. The computer-implemented method includes a first step to receive a user data associated with a plurality of users. In addition, the computer-implemented method includes a second step to collect a user activity data associated with the plurality of users. Further, the computer-implemented method includes a third step to analyze the user data and the user activity data based on one or more machine learning algorithms. Furthermore, the computer-implemented method includes a fourth step to create a plurality of user profiles associated with the plurality of users. Moreover, the computer-implemented method includes a fifth step to segregate the plurality of user profiles associated with the plurality of users. Also, the computer-implemented method includes a sixth step to identify each of the plurality of users based on analysis of the corresponding plurality of user profiles for initiating one or more marketing campaigns. The computer-implemented method includes a seventh step to trigger initialization of the one or more marketing campaigns associated with one or more advertisers based on a pre-defined criterion. The computer-implemented method includes an eighth step display to one or more advertisements associated with the one or more marketing campaigns based on identified users of the plurality of users. The plurality of users is associated with a plurality of communication devices. The user data is received with facilitation of the one or more telecommunication channels in real-time. The user activity data is collected in real-time. The analysis is performed based on training of a machine learning model. The analysis is performed based one or more patterns to identify creation of the plurality of user profiles. The analysis of the user data and the user activity data is done in real-time. Each of the plurality of user profiles of the corresponding plurality of users is created based on analyzed user data and user activity data. The plurality of user profiles is created in real-time. The segregation of the plurality of user profiles is based on one or more parameters. The plurality of user profiles is segregated in real-time. Each of the plurality of users is identified in real-time. The pre-defined criterion are associated with the plurality of communication devices based on the identified users of the plurality of users. The one or more marketing campaigns are triggered in the real-time. The one or more advertisements are displayed on the plurality of communication devices in the form of flash messages. The one or more advertisements are displayed on the plurality of communication devices in real-time. In addition, the advertising system with the processor selects the targeted identified user of the plurality of users for displaying the one or more advertisements. The advertising system with the processor customizes the selected targeted identified user of the plurality of users.

In an embodiment of the present disclosure, the advertising system includes the one or more telecommunication channels. In addition, the user data is received through the one or more telecommunication channels. The user data includes name, age, gender, location, contact number, email address, communication device, relationship status and date of birth.

In an embodiment of the present disclosure, the user activity data includes user click, website viewed, website searched, call time, network address, recharge details, uptime, browser data, timestamp and demographic data. In addition, a communication network provides a medium for the plurality of users to connect with the advertising system through the one or more communication devices.

In an embodiment of the present disclosure, the computer-implemented method may create the machine learning model to perform analysis of the user data and the user activity data. The machine learning model is trained based on the one or more patterns to identify creation of the plurality of user profiles from the analyzed user data and user activity data.

In an embodiment of the present disclosure, the computer-implemented method may send the plurality of user profiles to the one or more advertisers. The advertising system sends the plurality of user profiles to the one or more advertisers through the communication network.

In an embodiment of the present disclosure, the computer-implemented method may generate a plurality of groups associated with the plurality of user profiles based on segregated profiles of the plurality of user profiles using the one or more parameters. In addition, the one or more parameters include time of call, subscriber active services and language spoken. The plurality of groups is guided to the one or more advertisers through the communication network. In addition, each of the plurality of groups is generated and sent in real-time.

In an embodiment of the present disclosure, the computer-implemented method may receive the set of rules. The set of rules is received from server based on one or more inputs of an administrator. In addition, the one or more inputs includes optimal time for advertisement, optimal advertisement plan, optimal airtime balance, optimal season for advertisement, and optimal tariff advertising. The set of rules can be modified at the advertising system by the administrator in real-time.

In an embodiment of the present disclosure, each of the plurality of users is identified based on analysis of the corresponding plurality of user profiles for initiating the one or more marketing campaigns. The one or more marketing campaigns include advertisement goals of the one or more advertisers. In addition, the advertisement goals are targets wished to achieve by the one or more advertisers. Each of the plurality of users is identified for the one or more marketing campaigns in real-time.

In an embodiment of the present disclosure, the computer-implemented method may alert the one or more advertisers and the administrator based on the identified users of the plurality of users associated with the plurality of communication devices. The one or more advertisers and the administrator are alerted based on the pre-defined criterion of the plurality of communication devices. In addition, the pre-defined criterion includes end of call, end of data session, end of recharge, end of short message service, end of voice data, end of short message service data, and end of internet data

In an embodiment of the present disclosure, the plurality of communication devices receives the one or more advertisements based on the one or more marketing campaigns to identified and targeted user of the plurality of users. The one or more advertisements are displayed on the plurality of communication devices based on the analysis of the user data and the user activity data and segregation of the user profile of each of the plurality of users.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method for running highly targeted marketing campaigns through one or more telecommunication channels. The method corresponds to an advertising system. The method includes a first step to receive a user data associated with a plurality of users. In addition, the method includes a second step to collect a user activity data associated with the plurality of users. Further, the method includes a third step to analyze the user data and the user activity data based on one or more machine learning algorithms. Furthermore, the method includes a fourth step to create a plurality of user profiles associated with the plurality of users. Moreover, the method includes a fifth step to segregate the plurality of user profiles associated with the plurality of users. Also, the method includes a sixth step to identify each of the plurality of users based on analysis of the corresponding plurality of user profiles for initiating one or more marketing campaigns. The method includes a seventh step to trigger initialization of the one or more marketing campaigns associated with one or more advertisers based on a pre-defined criterion. The method includes an eighth step display to one or more advertisements associated with the one or more marketing campaigns based on identified users of the plurality of users. The plurality of users is associated with a plurality of communication devices. The user data is received with facilitation of the one or more telecommunication channels in real-time. The user activity data is collected in real-time. The analysis is performed based on training of a machine learning model. The analysis is performed based one or more patterns to identify creation of the plurality of user profiles. The analysis of the user data and the user activity data is done in real-time. Each of the plurality of user profiles of the corresponding plurality of users is created based on analyzed user data and user activity data. The plurality of user profiles is created in real-time. The segregation of the plurality of user profiles is based on one or more parameters. The plurality of user profiles is segregated in real-time. Each of the plurality of users is identified in real-time. The pre-defined criterion is associated with the plurality of communication devices based on the identified users of the plurality of users. The one or more marketing campaigns are triggered in the real-time. The one or more advertisements are displayed on the plurality of communication devices in the form of flash messages. The one or more advertisements are displayed on the plurality of communication devices in real-time. In addition, the advertising system selects the targeted identified users of the plurality of users for displaying the one or more advertisements. The advertising system customizes the selected targeted identified users of the plurality of users.

In a third example, a non-transitory computer-readable storage medium is provided. The non-transitory computer-readable storage medium encodes computer executable instructions that, when executed by at least one processor, performs a method for running highly targeted marketing campaigns through one or more telecommunication channels. The method corresponds to an advertising system. The method includes a first step to receive a user data associated with a plurality of users. In addition, the method includes a second step to collect a user activity data associated with the plurality of users. Further, the method includes a third step to analyze the user data and the user activity data based on one or more machine learning algorithms. Furthermore, the method includes a fourth step to create a plurality of user profiles associated with the plurality of users. Moreover, the method includes a fifth step to segregate the plurality of user profiles associated with the plurality of users. Also, the method includes a sixth step to identify each of the plurality of users based on analysis of the corresponding plurality of user profiles for initiating one or more marketing campaigns. The method includes a seventh step to trigger initialization of the one or more marketing campaigns associated with one or more advertisers based on a pre-defined criterion. The method includes an eighth step display to one or more advertisements associated with the one or more marketing campaigns based on identified users of the plurality of users. The plurality of users is associated with a plurality of communication devices. The user data is received with facilitation of the one or more telecommunication channels in real-time. The user activity data is collected in real-time. The analysis is performed based on training of a machine learning model. The analysis is performed based one or more patterns to identify creation of the plurality of user profiles. The analysis of the user data and the user activity data is done in real-time. Each of the plurality of user profiles of the corresponding plurality of users is created based on analyzed user data and user activity data. The plurality of user profiles is created in real-time. The segregation of the plurality of user profiles is based on one or more parameters. The plurality of user profiles is segregated in real-time. Each of the plurality of users is identified in real-time. The pre-defined criterion is associated with the plurality of communication devices based on the identified users of the plurality of users. The one or more marketing campaigns are triggered in the real-time. The one or more advertisements are displayed on the plurality of communication devices in the form of flash messages. The one or more advertisements are displayed on the plurality of communication devices in real-time. In addition, the advertising system selects the targeted identified users of the plurality of users for displaying the one or more advertisements. The advertising system customizes the selected targeted identified users of the plurality of users.

### BRIEF DESCRIPTION OF THE FIGURES

Having thus described the invention in general terms, reference will now be made to the accompanying drawings, which are not necessarily drawn to scale, and wherein:

FIG. 1 illustrates a block diagram of a system for running highly targeted marketing campaigns through one or more telecommunication channels, in accordance with various embodiments of the present disclosure;

FIGS. 2A and 2B illustrate a flowchart for running highly targeted marketing campaigns through one or more telecommunication channels, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

FIG. 1 illustrates a block diagram of a system 100 for running highly targeted marketing campaigns through one or more telecommunication channels, in accordance with another embodiment of the present disclosure. The marketing campaigns are personalized and non-intrusive. The system 100 includes a plurality of users 102, a plurality of communication devices 104, a communication network 106, a server 110, and an administrator 112. In addition, the system 100 includes one or more advertisers 116 and an advertising system 108. Further, the user identifier system 108 enables running highly targeted marketing campaigns through the one or more telecommunication channels associated with the one or more advertisers 116. In an embodiment of the present disclosure, the highly targeted marketing campaigns through the one or more telecommunication channels is performed for serving one or more advertisements to the plurality of users 102 in real-time. The advertisements are displayed in form of interactive flash messages using different communication channels triggered by certain actions. The actions include end of call, end of data session, recharge, end of SMS, end of bundle (Voice/SMS/Data) scenario immediately after standard information about the subscriber's call cost and his actual balance.

Furthermore, the system 100 enables the one or more advertisers 116 to increase efficiency of the highly targeted marketing campaigns for the plurality of users 102 for serving the one or more advertisements. In addition, a user of the plurality of users 102 may be any person or individual currently accessing a communication device of the plurality of communication devices 104. In an embodiment of the present disclosure, the communication device of the plurality of communication devices 104 is a portable communication device. The plurality of communication devices 104 includes but may not be limited to a smart phone, any other portable communication device known in the art having communication capabilities or any device having capability to communicate through a telecom network and is subscribed with at least one telecom operator. In addition, the plurality of communication devices 104 is associated with a specific type of operating system. The specific type of operating system associated with the plurality of communication devices 104 includes but may not be limited to an Android operating system, iOS, Mac operating system, Windows operating system, Bada operating system and Symbian operating system.

Further, the plurality of communication devices 104 includes an internet facility. In an embodiment of the present disclosure, the plurality of communication devices 104 is presently connected to the internet. In another embodiment of the present disclosure, the plurality of communication devices 104 is not connected to the internet. In an embodiment of the present disclosure, the plurality of communication devices 104 is connected to the internet through a data connection provided by the one or more telecommunication channels. In another embodiment of the present disclosure, the plurality of communication devices 104 is connected to an internet broadband system, a local area network, a wide area network, a digital or analog cable television network or any other communication network presently known in the art. The internet broadband system may be a wired system or a wireless system. In another embodiment of the present disclosure, the plurality of communication devices 104 may not have any internet facility.

In an embodiment of the present disclosure, the one or more advertisements are displayed for generating revenue based on number of value added services, number of telecom services availed, number of clicks and the like. In an embodiment of the present disclosure, the one or more advertisements are displayed after the exchange of information between the plurality of users 102 through the one or more telecommunication channels. In an example, a user X interconnects with a user Y over a telephonic call through a telecommunication channel of the one or more telecommunication channel and views advertisement after the telephonic call disconnects. In another embodiment of the present disclosure, the one or more advertisements are displayed during the interactions of the plurality of users 102 through the one or more telecommunication channels.

In addition, the one or more telecommunication channels are interlinked with the advertising system 108. The one or more telecommunication channels send a user data associated with the user of the plurality of users 102 to the advertising system 108 through the communication network 106. In an embodiment of the present disclosure, the user data enables the advertising system 108 to collect information associated with the user of the plurality of users 102 and the corresponding plurality of communication device 104. The user data includes but may not be limited to name, age, gender, location, contact number, email address, user network information, user telecommunication service provider, communication device, real time user activity over the telecom channels such as calling, messaging or any other actions. The one or more telecommunication channels send the user data in real-time.

In addition, the one or more telecommunication channels transfer a user activity data associated with the plurality of users 102 to the advertising system 108 through the communication network 106. In an embodiment of the present disclosure, the user activity data enables the advertising system 108 to analyze and understand the interests of the user of the plurality of users 102. The user activity data includes but may not be limited to user click, website viewed, website searched, call time, network address, recharge details, uptime, browser data, timestamp, and demographic data. Further, the one or more telecommunication channels transfer the user activity data in real-time.

In addition, the advertising system 108 analyzes the user data and the user activity data based on one or more machine learning algorithms. In an embodiment of the present disclosure, the one or more machine learning algorithms include a decision tree algorithm and a random forest algorithm. In another embodiment of the present disclosure, the one or more machine learning algorithms include but may not be limited to prediction algorithms, deep learning algorithms, natural language processing algorithm and the like. However, the one or more machine learning algorithms are not limited to the above-mentioned algorithms. The analysis of the user data and the user activity data based on the one or more machine learning algorithms is done in real-time

In addition, the advertising system 108 creates a machine learning model to perform creation of a plurality of user profiles and identification of the user based on analysis of the user data and the user activity data. The machine learning model is trained based on analyzed user data and user activity data based on one or more patterns from the user data and the user activity data. Further, the machine learning model is trained to analyze the user data and the user activity data. Furthermore, the machine learning model is trained to create the plurality of user profiles. Moreover, the machine learning model is trained to identify the targeted user from the created plurality of user profiles. In an embodiment of the present disclosure, the machine learning model is trained using supervised machine learning model. In another embodiment of the present disclosure, the machine learning model is trained using un-supervised machine learning model.

In addition, the advertising system 108 creates the plurality of user profiles associated with the plurality of users 102. Further, each of the plurality of user profiles of corresponding plurality of users is created based on analyzed user data and user activity data through the machine learning model. The advertising system 108 creates the plurality of user profiles in real-time. Furthermore, the advertising system 108 sends the plurality of user profiles to the one or more advertisers 116. Moreover, the advertising system 108 sends the plurality of user profiles to the one or more advertisers 116 through the communication network 106.

In addition, the advertising system 108 segregates the plurality of user profiles associated with the plurality of users 102. The advertising system 108 segregates the plurality of user profiles based on one or more parameters. The advertising system 108 segregates the plurality of user profiles in real-time. Further, the advertising system 108 generates a plurality of groups associated with the plurality of users 102 based on segregated profiles of the plurality of user profiles using the one or more parameters. The one or more parameters include but may not be limited to time of call, subscriber active services and language spoken and multiple activities performed over the one or more telecommunication channels. Furthermore, the plurality of groups is sent to the one or more advertisers 116 through the communication network 106.

In addition, the one or more advertisers 116 are associated through one or more advertisement supplying intermediaries. Further, the advertisement supplying intermediaries enables a connection or link with the one or more advertisers 116. In an embodiment of the present disclosure, the advertisement supplying intermediaries is a platform for buying and selling of advertisement inventory for the one or more advertisers 116. In addition, the plurality of communication devices 104 is associated with the communication network 106. In an embodiment of the present disclosure, the plurality of communication devices 104 is associated with the one or more advertisers 116 through the communication network 106.

The communication network 106 enables the plurality of communication devices 104 to connect to the internet. Further, the medium for communication may be infrared, microwave, radio frequency (RF) and the like. The communication network 106 includes but may not be limited to a local area network, a metropolitan area network, a wide area network, a virtual private network, a global area network and a home area network. The communication network 106 is a structure of various nodes or communication devices connected to each other through a network topology method. The network topology includes a bus topology, a star topology, a mesh topology and the like.

In addition, the one or more telecommunication channels and the one or more advertisers 116 are associated with the advertising system 108. In an embodiment of the present disclosure, the one or more telecommunication channels and the one or more advertisers 116 are associated with the advertising system 108 through the communication network 106. Moreover, the advertising system 108 performs the reception, collection, analysis, and identification of each of the plurality of users 102 connected on the one or more telecommunication channels for serving the one or more advertisements in real time.

In addition, the advertising system 108 receives a set of rules. The set of rules is received from a server 110 based on the one or more inputs of an administrator 112. The one or more inputs include but may not be limited to optimal time for advertisement, optimal advertisement plan, optimal airtime balance, optimal season for advertisement, and optimal tariff advertising. Further, the set of rules can be modified by the administrator in real-time.

In addition, the advertising system 108 identifies each of the plurality of users 102 based on analysis of corresponding plurality of user profiles for initiating one or more marketing campaigns. Further, the one or more marketing campaigns include advertisement goals of the one or more advertisers related to the one or more telecommunication channels. The advertisement goals are targets wished to achieve by the one or more advertisers 116. Each of the plurality of users 102 is identified for the one or more marketing campaigns in real-time. In an embodiment of the present disclosure, each of the plurality of users 102 is identified based on the analysis done by the machine learning model and the segregated plurality of user profiles in the plurality of groups.

The advertising system 108 alerts the one or more telecommunication channels, the one or more advertisers 116 and the administrator 112 based on identified user of the plurality of users 102 associated with the plurality of communication devices 104. The advertising system 108 triggers initialization of the one or more marketing campaigns associated with the one or more advertisers 116 based on a pre-defined criterion of the plurality of communication devices 104. The pre-defined criterion includes but may not be limited to end of call, end of data session, end of recharge, end of short message service, end of voice data, end of short message service and the like. The pre-defined criterion may not be limited to the above stated actions.

Further, the advertising system 108 displays the one or more advertisements associated with the one or more marketing campaigns based on identified plurality of users 102. In an embodiment of the present disclosure, the one or more advertisements are displayed on the plurality of communication devices 104 in the form of flash messages. In another embodiment of the present disclosure, the one or more advertisements are displayed on the plurality of communication devices 104 in the form of text messages. The one or more advertisements are displayed on the plurality of communication devices 104 in real-time. The one or more advertisements are displayed on the plurality of communication devices 104 in the form of flash messages based on the analysis of the user data and the user activity data and segregation of the user profile of each of the plurality of users 102.

In an embodiment of the present disclosure, the one or more advertisements displayed are associated with the interests of the user of the plurality of users 102. In an embodiment of the present disclosure, the one or more advertisements correspond to a content viewing history of the plurality of users 102 for attracting more number of clicks from the plurality of users 102 in order to increase the revenue generation.

In addition, the one or more advertisers 116 and the advertising system 108 are associated with the server 110. In an embodiment of the present disclosure, the one or more advertisers 116 and the advertising system 108 are associated with the server 110 through the communication network 106. Further, the system 100 includes the database 110a. In general, the server 110 is a computer program or device that provides functionality for other programs or devices. The server 110 provides various functionalities, such as sharing data or resources among multiple clients, or performing computation for a client. However, those skilled in the art would appreciate that the advertising system 108 is connected to more number of servers 110. Furthermore, it may be noted that the server 110 includes the database 110a. However, those skilled in the art would appreciate that more number of the servers 110 include more numbers of database 110a.

The database 110a stores different sets of information associated with various components of the advertising system 108. In general, the database 110a is used to hold general information and specialized data, such as characteristics data of the plurality of users 102, data of the plurality of communication devices 104, data of the one or more advertisers 116 and the like. For examples, the database 110a includes characteristic data of the plurality of users 102 and the pre-defined instructions. The database 110a stores the information of the one or more telecommunication channels, the profiles of the plurality of users 102, demographic information of the plurality of users 102 and the like. The database 110a organizes the data using model such as relational models or hierarchical models.

The server 110 is associated with the administrator 112. In general, the administrator 112 manages the different components in the advertising system 108. The administrator 112 coordinates the activities of the components involved in the advertising system 108. The administrator 112 is any person or individual who monitors the working of the advertising system 108 and the server 110 in real time. The administrator 112 monitors the working of the advertising system 108 and the server 110 through a communication device. The communication device includes the laptop, the desktop computer, the tablet, a personal digital assistant and the like.

FIGS. 2A and 2B illustrate a flow chart 200 of the method for running highly targeted marketing campaigns through one or more telecommunication channels, in accordance with various embodiments of the present disclosure. It may be noted that in order to explain the method steps of the flowchart 200, references will be made to the elements explained in FIG. 1. The flow chart 200 starts at step 202. At step 204, the advertising system 108 receives the user data associated with the plurality of users 102. At step 206, the advertising system 108 collects the user activity data associated with the plurality of users 102. At step 208, the advertising system 108 analyzes the user data and the user activity data based on the one or more machine learning algorithms. At step 210, the advertising system 108 creates the plurality of user profiles associated with the plurality of users 102. At step 212, the advertising system 108 segregates the plurality of user profiles associated with the plurality of users 102. At step 214, the advertising system 108 identifies each of the plurality of users 102 based on analysis of corresponding plurality of user profiles for initiating the one or more marketing campaigns. At step 216, the advertising system 108 triggers initialization of the one or more marketing campaigns associated with the one or more advertisers based on the pre-defined criterion. At step 218, the advertising system 108 displays the one or more advertisements associated with the one or more marketing campaigns based on identified plurality of users.

The flow chart 200 terminates at step 220. It may be noted that the flowchart 200 is explained to have above stated process steps; however, those skilled in the art would appreciate that the flowchart 200 may have more/less number of process steps which may enable all the above stated embodiments of the present disclosure.

FIG. 3 illustrates the block diagram of a computing device 300, in accordance with various embodiments of the present disclosure. The computing device 300 includes a bus 302 that directly or indirectly couples the following devices: memory 304, one or more processors 206, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data.

The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The present disclosure has several advantages over the prior art. The present disclosure provides specific advertisement for the specific user of the plurality of users according to the user interest in real-time. The present disclosure provides segregation of the users of the plurality of users based on the user interests to the group of the plurality of groups in real-time. The present disclosure provides identification of the user based on the plurality of user profiles on the one or more telecommunication channels for displaying relevant one or more advertisement in real-time.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for running highly targeted marketing campaigns through one or more telecommunication channels, the computer-implemented method comprising:
receiving, at an advertising system with a processor, a user data associated with a plurality of users, wherein the plurality of users is associated with a plurality of communication devices, wherein the user data is received with facilitation of the one or more telecommunication channels in real-time;
collecting, at the advertising system with the processor, a user activity data associated with the plurality of users, wherein the plurality of users is associated with the plurality of communication devices, wherein the user activity data is collected in real-time;
analyzing, at the advertising system with the processor, the user data and the user activity data based on one or more machine learning algorithms, wherein the analysis is performed based on training of a machine learning model, wherein analysis is performed based one or more patterns to enable creation of a plurality of user profiles, wherein the analysis of the user data and the user activity data is done in real-time;
creating, at the advertising system with the processor, the plurality of user profiles associated with the plurality of users, wherein each of the plurality of user profiles of corresponding plurality of users is created based on analyzed user data and user activity data, wherein the plurality of user profiles is created in real-time;
segregating, at the advertising system with the processor, the plurality of user profiles associated with the plurality of users, wherein the segregation of the plurality of user profiles is based on one or more parameters, wherein the plurality of user profiles is segregated in real-time;
identifying, at the advertising system with the processor, each of the plurality of users based on analysis of corresponding plurality of user profiles for initiating one or more marketing campaigns, wherein each of the plurality of users is identified in real-time;
triggering, at the advertising system with the processor, initialization of the one or more marketing campaigns associated with one or more advertisers based on a pre-defined criterion, wherein the pre-defined criterion are associated with the plurality of communication devices based on identified users of the plurality of users, wherein the one or more marketing campaigns are triggered in the real-time; and
displaying, at the advertising system with the processor, one or more advertisements associated with the one or more marketing campaigns based on the identified users of the plurality of users, wherein the one or more advertisements are displayed on the plurality of communication devices in the form of flash messages, wherein the one or more advertisements are displayed on the plurality of communication devices in real-time,
wherein the advertising system with the processor selects the targeted identified user of the plurality of users for displaying the one or more advertisements, wherein the advertising system with the processor customizes the selected targeted identified user of the plurality of users.

2. The computer-implemented method as recited in claim 1, wherein the advertising system with the processor comprises the one or more telecommunication channels, wherein the user data is received through the one or more telecommunication channels, wherein the user data comprises name, age, gender, location, contact number, email address, communication device, relationship status and date of birth.

3. The computer-implemented method as recited in claim 1, wherein the user activity data comprises user click, website viewed, website searched, call time, network address, recharge details, uptime, browser data, timestamp and demographic data, wherein a communication network provides a medium for the plurality of users to connect with the advertising system through the one or more communication devices.

4. The computer-implemented method as recited in claim 1, further comprising creating, at the advertising system with the processor, the machine learning model to perform analysis of the user data and the user activity data, wherein the machine learning model is trained based on the one or more patterns to identify creation of the plurality of user profiles from the analyzed user data and user activity data.

5. The computer-implemented method as recited in claim 1, further comprising sending, at the advertising system with the processor, the plurality of user profiles to the one or more advertisers, wherein the advertising system sends the plurality of user profiles to the one or more advertisers through the communication network.

6. The computer-implemented method as recited in claim 1, further comprising generating, at the advertising system with the processor, a plurality of groups associated with the plurality of user profiles based on segregated profiles of the plurality of user profiles using the one or more parameters, wherein the one or more parameters comprise time of call, subscriber active services and language spoken, wherein the plurality of groups is guided to the one or more advertisers through the communication network, wherein each of the plurality of groups is generated and sent in real-time.

7. The computer-implemented method as recited in claim 1, further comprising receiving, at the advertising system with the processor, a set of rules, wherein the set of rules is received from server based on one or more inputs of an administrator, wherein the one or more inputs comprise optimal time for advertisement, optimal advertisement plan, optimal airtime balance, optimal season for advertisement, and optimal tariff advertising, wherein the set of rules can be modified at the advertising system by the administrator in real-time.

8. The computer-implemented method as recited in claim 1, each of the plurality of users is identified based on analysis of corresponding plurality of user profiles for initiating the one or more marketing campaigns, wherein the one or more marketing campaigns comprise advertisement goals of the one or more advertisers, wherein the advertisement goals are targets wished to achieve by the one or more advertisers, wherein each of the plurality of users is identified for the one or more marketing campaigns in real-time.

9. The computer-implemented method as recited in claim 1, further comprising alerting, at the advertising system with the processor, the one or more advertisers and the administrator based on the identified users of the plurality of users associated with the plurality of communication devices through the communication network, wherein the one or more advertisers and the administrator are alerted based on the pre-defined criterion of the plurality of communication devices, wherein the pre-defined criterion comprises end of call, end of data session, end of recharge, end of short message service, end of voice data, end of short message service data, and end of internet data.

10. The computer-implemented method as recited in claim 1, the plurality of communication devices receives the one or more advertisements associated with the one or more advertisers based on the one or more marketing campaigns to identified and targeted user of the plurality of users, wherein the one or more advertisements are displayed on the plurality of communication devices in the form of flash messages based on the analysis of the user data and the user activity data and segregation of the user profile of each of the plurality of users.

11. A computer system comprising:
one or more processors; and
a memory coupled to the one or more processors, the memory for storing instructions which, when executed by the one or more processors, cause the one or more processors to perform a method for running highly targeted marketing campaigns through one or more telecommunication channels, the method comprising:
receiving, at an advertising system, a user data associated with a plurality of users, wherein the plurality of users is associated with a plurality of communication devices, wherein the user data is received with facilitation of the one or more telecommunication channels in real-time;
collecting, at the advertising system, a user activity data associated with the plurality of users, wherein the plurality of users is associated with the plurality of communication devices, wherein the user activity data is collected in real-time;
analyzing, at the advertising system, the user data and the user activity data based on one or more machine learning algorithms, wherein the analysis is performed based on training of a machine learning model, wherein analysis is performed based one or more patterns to identify creation of a plurality of user profiles, wherein the analysis of the user data and the user activity data is done in real-time;
creating, at the advertising system, the plurality of user profiles associated with the plurality of users, wherein each of the plurality of user profiles of corresponding plurality of users is created based on analyzed user data and user activity data, wherein the plurality of user profiles is created in real-time;
segregating, at the advertising system, the plurality of user profiles associated with the plurality of users, wherein the segregation of the plurality of user profiles is based on one or more parameters, wherein the plurality of user profiles is segregated in real-time;
identifying, at the advertising system, each of the plurality of users based on analysis of corresponding plurality of user profiles for initiating one or more marketing campaigns, wherein each of the plurality of users is identified in real-time;
triggering, at the advertising system, initialization of the one or more marketing campaigns associated with one or more advertisers based on a pre-defined criterion, wherein the pre-defined criterion are associated with the plurality of communication devices based on identified users of the plurality of users, wherein the one or more marketing campaigns are triggered in the real-time; and
displaying, at the advertising system, one or more advertisements associated with the one or more marketing campaigns based on the identified users of the plurality of users, wherein the one or more advertisements are displayed on the plurality of communication devices in the form of flash messages, wherein the one or more advertisements are displayed on the plurality of communication devices in real-time.
wherein the advertising system selects the targeted identified user of the plurality of users for displaying the one or more advertisements, wherein the advertising system customizes the selected targeted identified user of the plurality of users.

12. The computer system as recited in claim 11, wherein the advertising system comprises the one or more telecommunication channels, wherein the user data is received through the one or more telecommunication channels, wherein the user data comprises name, age, gender, location, contact number, email address, communication device, relationship status and date of birth.

13. The computer system as recited in claim 11, wherein the user activity data comprises user click, website viewed, website searched, call time, network address, recharge details, uptime, browser data, timestamp and demographic data, wherein a communication network provides a medium for the plurality of users to connect with the advertising system through the one or more communication devices.

14. The computer system as recited in claim 11, further comprising creating, at the advertising system, the machine learning model to perform analysis of the user data and the user activity data, wherein the machine learning model is trained based on the one or more patterns to identify creation of the plurality of user profiles from the analyzed user data and user activity data.

15. The computer system as recited in claim 11, further comprising sending, at the advertising system, the plurality of user profiles to the one or more advertisers.

16. The computer system as recited in claim 11, further comprising generating, at the advertising system, a plurality of groups associated with the plurality of user profiles based on segregated profiles of the plurality of user profiles using the one or more parameters, wherein the one or more parameters comprise time of call, subscriber active services and language spoken, wherein the plurality of groups is guided to the one or more advertisers through the communication network, wherein each of the plurality of groups is generated and sent in real-time.

17. The computer system as recited in claim 11, further comprising receiving, at the advertising system, a set of rules, wherein the set of rules is received from a server based on one or more inputs of an administrator, wherein the one or more inputs comprise optimal time for advertisement, optimal advertisement plan, optimal airtime balance, optimal season for advertisement, and optimal tariff advertising, wherein the set of rules can be modified at the advertising system by the administrator in real-time.

18. The computer system as recited in claim 11, further comprising alerting, at the advertising system, the one or more advertisers and the administrator based on the identified users of the plurality of users associated with the plurality of communication devices through the communication network, wherein the one or more advertisers and the administrator are alerted based on the pre-defined criterion of the plurality of communication devices, wherein the pre-defined criterion comprises end of call, end of data session, end of recharge, end of short message service, end of voice data, end of short message service data, and end of internet data.

19. The computer system as recited in claim 1, the plurality of communication devices receives the one or more advertisements associated with the one or more advertisers based on the one or more marketing campaigns to identified and targeted users of the plurality of users, wherein the one or more advertisements are displayed on the plurality of communication devices in the form of flash messages based on the analysis of the user data and the user activity data and segregation of the user profile of each of the plurality of users.

20. A non-transitory computer-readable storage medium encoding computer executable instructions that, when executed by at least one processor, performs a method for running highly targeted marketing campaigns through one or more telecommunication channels, the method comprising:
receiving, at a computing device, a user data associated with a plurality of users, wherein the plurality of users is associated with a plurality of communication devices, wherein the user data is received with facilitation of the one or more telecommunication channels in real-time;
collecting, at the computing device, a user activity data associated with the plurality of users, wherein the plurality of users is associated with the plurality of communication devices, wherein the user activity data is collected in real-time;
analyzing, at the computing device, the user data and the user activity data based on one or more machine learning algorithms, wherein the analysis is performed based on training of a machine learning model, wherein analysis is performed based one or more patterns to identify creation of a plurality of user profiles, wherein the analysis of the user data and the user activity data is done in real-time;
creating, at the computing device, the plurality of user profiles associated with the plurality of users, wherein each of the plurality of user profiles of corresponding plurality of users is created based on analyzed user data and user activity data, wherein the plurality of user profiles is created in real-time;
segregating, at the computing device, the plurality of user profiles associated with the plurality of users, wherein the segregation of the plurality of user profiles is based on one or more parameters, wherein the plurality of user profiles is segregated in real-time;
identifying, at the computing device, each of the plurality of users based on analysis of corresponding plurality of user profiles for initiating one or more marketing campaigns, wherein each of the plurality of users is identified in real-time;
triggering, at the computing device, initialization of the one or more marketing campaigns associated with one or more advertisers based on a pre-defined criterion, wherein the pre-defined criterion are associated with the plurality of communication devices based on identified users of the plurality of users, wherein the one or more marketing campaigns are triggered in the real-time; and
displaying, at the computing device, one or more advertisements associated with the one or more marketing campaigns based on the identified users of the plurality of users, wherein the one or more advertisements are displayed on the plurality of communication devices in the form of flash messages, wherein the one or more advertisements are displayed on the plurality of communication devices in real-time.
wherein the advertising system selects the targeted identified user of the plurality of users for displaying the one or more advertisements, wherein the advertising system customizes the selected targeted identified user of the plurality of users
